(19) United States
(12) Patent Application Publication
(10) Pub. No.: US 2025/0102390 A1
(43) Pub. Date: Mar. 27, 2025

(54) CAPACITIVE PRESSURE SENSOR

(71) Applicant: HORIBA STEC, Co., Ltd., Kyoto (JP)

(72) Inventors: Akira KUWAHARA, Kyoto (JP); Sotaro KISHIDA, Kyoto (JP)

(73) Assignee: HORIBA STEC, Co., Ltd., Kyoto (JP)

(21) Appl. No.: 18/824,086

(22) Filed: Sep. 4, 2024

(30) Foreign Application Priority Data
Sep. 25, 2023 (JP) 2023-161760
Jul. 4, 2024 (JP) 2024-108328

(51) Int. Cl. G01L 19/06; G01L 9/00

(52) U.S. Cl. CPC G01L 19/0627; G01L 9/0072

(57) ABSTRACT

The present invention is intended to simplify the configuration of the baffle and prevent deposition on the diaphragm, and includes: a housing surrounding a pressure receiving surface of the diaphragm to form a measurement chamber, the housing having a gas introduction port for introducing a gas into the measurement chamber; and a baffle member provided in the measurement chamber, in which the baffle member includes: a facing surface portion facing the gas introduction port; and an surrounding surface portion provided closer to a side of the gas introduction port than the facing surface portion and surrounding a periphery of the gas introduction port, and the surrounding surface portion includes a flow passage portion that allows a gas introduced from the gas introduction port to flow from an end portion on the side of the gas introduction port side toward a side of the diaphragm.

This application claims priority of Japanese Applications 2023-161760 filed on Sep. 25, 2023, and 2024-108328 filed on Jul. 4, 2024, both of which are incorporated herein by reference in their entireties.

### BACKGROUND OF THE INVENTION

### 1. Technical Field

The present invention relates to a capacitive pressure sensor.

### 2. Description of the Related Art

The capacitive pressure sensor measures pressure by detecting a change in capacitance between a diaphragm and a fixed electrode that are displaced by pressure.

This capacitive pressure sensor can be used, for example, for pressure measurement of gas during a semiconductor manufacturing process. Here, the gas during the semiconductor manufacturing process is often highly reactive or high-temperature. Then, in a case where the temperature difference between the gas and the diaphragm during the semiconductor manufacturing process is large, a gas component or a decomposed gas component is deposited on the diaphragm, which adversely affects the sensor output.

For this reason, conventionally, in a housing in which a diaphragm is disposed, a baffle plate (baffle) is disposed between a gas introduction port of the housing and the diaphragm.

Specifically, those described in JP 2023-525634 A and JP 6815221 B are considered. In the baffle of JP 2023-525634 A, a baffle orifice is formed between the inner baffle structure and the outer baffle structure. This baffle has a configuration in which the inflowing gas hits the inner baffle structure and the outer baffle structure and passes through the baffle orifice. In addition, the baffle of JP 6815221 B has a flat plate shape, and is configured in a manner that a gas hits a central portion of a plate surface, bypasses the plate surface, and passes through a clearance formed around the baffle.

However, in any of the baffles described above, the path of the flowed gas cannot be sufficiently secured, and the effect of reducing the deposition amount on the diaphragm cannot be sufficiently exhibited. Note that, although it is conceivable to form the baffle into a complicated flow path such as a labyrinth shape (labyrinth shape), the baffle may be clogged by deposits or the like, resulting in poor responsiveness.

### PRIOR ART DOCUMENT

Patent Document1; JP 2023-525634 A
Patent Document2; JP 6815221 B

### SUMMARY OF THE INVENTION

Therefore, the present invention has been made to solve the above-described problem, and an object of the present invention is to prevent deposition on a diaphragm while simplifying the configuration of a baffle.

That is, the capacitive pressure sensor according to the present invention measures pressure by detecting a change in capacitance between a diaphragm and a fixed electrode displaced by pressure, and includes: a housing surrounding a pressure receiving surface of the diaphragm to form a measurement chamber, the housing having a gas introduction port for introducing a gas into the measurement chamber; and a baffle member provided in the measurement chamber, in which the baffle member includes: a facing surface portion facing the gas introduction port; and an surrounding surface portion provided closer to a side of the gas introduction port than the facing surface portion and surrounding a periphery of the gas introduction port, and the surrounding surface portion includes a flow passage portion that allows a gas introduced from the gas introduction port to flow from an end portion on the side of the gas introduction port side toward a side of the diaphragm.

With such a capacitive pressure sensor, the gas introduced from the gas introduction port hits the facing surface portion and the traveling direction is reversed, and the gas flows from the flow passage portion formed at the end portion of the surrounding surface portion on the gas introduction port side to the diaphragm side. As a result, it is possible to sufficiently secure the path of the introduced gas, mainly deposit the gas component or the decomposed gas component in the facing surface portion and the surrounding surface portion, and reduce the deposition on the diaphragm. In addition, the baffle member has a bottomed tubular shape including the facing surface portion and the surrounding surface portion, the configuration of the baffle can be simplified, and the possibility of deterioration of responsiveness due to clogging of deposits or the like is extremely low. Further, since the baffle member has a bottomed tubular shape, more deposits can be accumulated.

As a specific embodiment of the flow passage portion, it is desirable that a plurality of the flow passage portions is provided in the circumferential direction in the surrounding surface portion.

With this configuration, since the gas can flow from the plurality of flow passage portions to the diaphragm side, responsiveness of pressure measurement can be improved. In addition, by providing a plurality of flow passage portions, the size of each flow passage portion can be reduced, the flow path of the gas can be complicated, and the deposition effect in the baffle member can be improved.

It is desirable that the baffle member includes a joining protruding portion for joining with an inner surface of the housing, and the joining protruding portion is provided corresponding to the flow passage portion as viewed from the gas introduction port. Here, a surface of the joining protruding portion facing the gas introduction port is a flow changing surface that changes a flow of a gas flowing from the flow passage portion to the diaphragm side.

With this configuration, the gas flowing from the flow passage portion to the diaphragm side hits the joining protruding portion, and the gas component and the decomposed gas component in the joining protruding portion can be deposited. This also makes it possible to reduce the deposition on the diaphragm.

It is desirable that the housing has a flat surface portion in which the gas introduction port is formed, and an end portion of the surrounding surface portion on the side of the gas introduction port is provided in contact with the flat surface portion.

With this configuration, the introduced gas hits the facing surface portion and flows through the flow passage portion reliably after the traveling direction is reversed, and the deposition effect on the baffle member can be improved.

It is desirable that the housing includes an inner protruding portion protruding inward from the baffle member on a side opposite to the gas introduction port with respect to the baffle member.

With this configuration, the gas flowing through the flow passage portion of the baffle member to the diaphragm side hits the inner protruding portion, and the gas component and the decomposed gas component in the inner protruding portion can be deposited. This also makes it possible to reduce the deposition on the diaphragm.

In addition, it is desirable that the capacitive pressure sensor according to the present invention further includes a baffle plate provided separately from the baffle member and interposed between the baffle member and the gas introduction port.

With this configuration, it is possible to deposit not only the baffle member described above but also a gas component and a decomposed gas component on the baffle plate. As a result, the deposition on the diaphragm can be further reduced.

As a specific embodiment of the baffle plate, it is desirable that a plurality of slits is formed in the baffle plate.

In order to complicate a path through which the gas passes through the slit of the baffle plate, it is desirable that the plurality of slits be formed at positions different from the flow passage portion in the circumferential direction.

As described above, according to the present invention, it is possible to prevent the baffle from being deposited on the diaphragm while simplifying the configuration of the baffle.

### BRIEF DESCRIPTION OF THE DRAWINGS

FIG. 1 is a cross-sectional view schematically illustrating a configuration of a capacitive pressure sensor according to an embodiment of the present invention;

FIG. 2 is a partially enlarged cross-sectional view of a baffle member according to the embodiment;

FIG. 3(a) is an upper perspective view of the baffle member and FIG. 3(b) is a lower perspective view of the baffle member according to the embodiment;

FIG. 4 is a partially enlarged cross-sectional view schematically illustrating a flow of gas according to the embodiment;

FIG. 5 is a cross-sectional view schematically illustrating a configuration of a capacitive pressure sensor according to a modification;

FIG. 6 is an upper perspective view of a baffle plate according to a modification;

FIG. 7 is a cross-sectional view schematically illustrating a configuration of a capacitive pressure sensor according to a modification;

FIG. 8 is a cross-sectional view illustrating a positional relationship between a slit of a baffle plate and a flow passage portion of a baffle member according to a modification;

FIG. 9 is a cross-sectional view schematically illustrating a configuration of a capacitive pressure sensor according to a modification; and

FIG. 10 is a plan view of a baffle member integrated with a housing according to a modification.

### DETAILED DESCRIPTION

Hereinafter, an embodiment of a capacitive pressure sensor according to the present invention will be described with reference to the drawings.

Note that any of the drawings illustrated below is schematically omitted or exaggerated as appropriate for easy understanding. The same components are denoted by the same reference numerals, and the description thereof will be omitted as appropriate.

### <Basic Configuration of Capacitive Pressure Sensor 100>

The capacitive pressure sensor 100 according to the present embodiment measures pressure by detecting a change in capacitance between a diaphragm 2 and a fixed electrode 3 that are displaced by pressure.

The capacitive pressure sensor 100 is used, for example, in a semiconductor manufacturing process and measures the pressure of gas during the semiconductor manufacturing process. Note that the capacitive pressure sensor 100 can be used not only in a semiconductor manufacturing process but also in other processes.

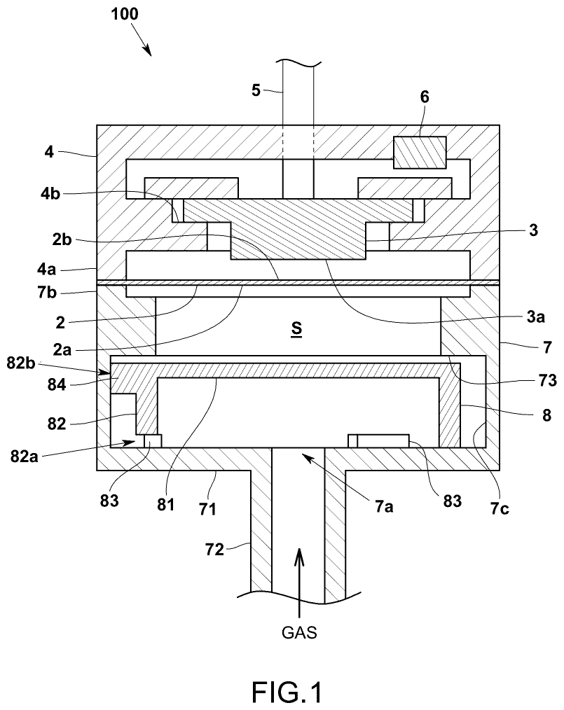

Specifically, as illustrated in FIG. 1, the capacitive pressure sensor 100 includes the diaphragm 2 having a pressure receiving surface 2a that receives a pressure of a gas, the fixed electrode 3 disposed to form a gap with a surface 2b (hereinafter, back surface 2b) of the diaphragm 2 on a side opposite to the pressure receiving surface 2a, and a support body 4 that supports the diaphragm 2 and the fixed electrode 3.

The diaphragm 2 is elastically deformed by a minute pressure change received by the pressure receiving surface 2a, and is a metal thin plate excellent in corrosion resistance and heat resistance. The diaphragm 2 of the present embodiment can be formed of a Ni—Co alloy containing tungsten, molybdenum, titanium, chromium, or the like, with nickel and cobalt as main components. In addition, the diaphragm 2 may be formed of a Ni alloy containing nickel as a main component and iron, chromium, niobium, or the like, or may be formed of stainless steel. Note that the diaphragm 2 has a disk shape in a natural state, and its thickness can be, for example, 5 μm or more and 200 μm or less in order to improve the sensitivity to the pressure change of the gas.

The fixed electrode 3 constitutes a capacitor together with the diaphragm 2. The fixed electrode 3 is provided in a manner that its distal end surface 3a faces the back surface 2b of the diaphragm 2 with a predetermined gap. In addition, a signal extraction unit 5 such as a lead wire for detecting a change in capacitance is connected to an upper end portion of the fixed electrode 3 (an end portion opposite to the diaphragm 2). The signal extraction unit 5 is connected to an arithmetic circuit (not illustrated) that converts the amount of change in capacitance into a pressure signal and outputs the pressure signal.

The support body 4 supports the diaphragm 2 and the fixed electrode 3 in a manner that the back surface 2b of the diaphragm 2 and the distal end surface 3a of the fixed electrode 3 form a predetermined gap. In the support body 4 of the present embodiment, the distal end portion 4a has a cylindrical shape, and the peripheral edge portion of the diaphragm 2 on the back surface 2b side is joined. In addition, a fixing portion 4b for fixing the fixed electrode 3 is provided inside the support body 4, and the fixed electrode 3 is fixed to the fixing portion 4b. In addition, a getter material 6 made of a material that adsorbs excess gas and maintains the degree of vacuum is provided inside the support body 4.

Then, as illustrated in FIG. 1, the capacitive pressure sensor 100 of the present embodiment includes a housing 7 that surrounds the pressure receiving surface 2a of the diaphragm 2 to form the measurement chamber S, and is provided with a gas introduction port 7a for introducing gas into the measurement chamber S, and a baffle member 8 provided to cover the gas introduction port 7a in the measurement chamber S.

In the housing 7, the distal end portion 7b has a cylindrical shape and is joined to the peripheral edge portion on the pressure receiving surface 2a side of the diaphragm 2. As a result, the measurement chamber S surrounding the pressure receiving surface 2a is formed. In addition, in the housing 7, the gas introduction port 7a is formed at a position facing the pressure receiving surface 2a of the diaphragm 2. Here, the housing 7 has a flat surface portion 71 in which the gas introduction port 7a is formed. Note that the housing 7 has a gas introduction pipe 72 for introducing gas into the gas introduction port 7a, and the gas introduction pipe 72 is connected to an external gas pipe (not illustrated).

The baffle member 8 obstructs the flow of the gas introduced from the gas introduction port 7a into the measurement chamber S to reduce the deposition on the diaphragm 2.

Specifically, as illustrated in FIGS. 1 to 4, the baffle member 8 includes a facing surface portion 81 facing the gas introduction port 7a, and a surrounding surface portion 82 provided on the gas introduction port 7a side of the facing surface portion 81 and surrounding the periphery of the gas introduction port 7a.

Here, the facing surface portion 81 has, for example, a flat plate shape, and the surrounding surface portion 82 has, for example, a tubular shape such as a cylindrical shape. In addition, the facing surface portion 81 and the surrounding surface portion 82 are continuously provided, and a connection portion between the facing surface portion 81 and the surrounding surface portion 82 has a structure without a clearance. The baffle member 8 of the present embodiment has a bottomed tubular shape such as a bottomed cylindrical shape, and a bottom wall portion thereof serves as the facing surface portion 81 and a side wall portion thereof serves as the surrounding surface portion 82.

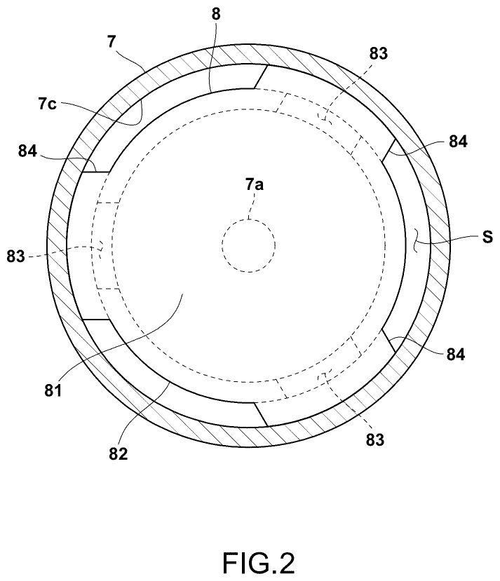

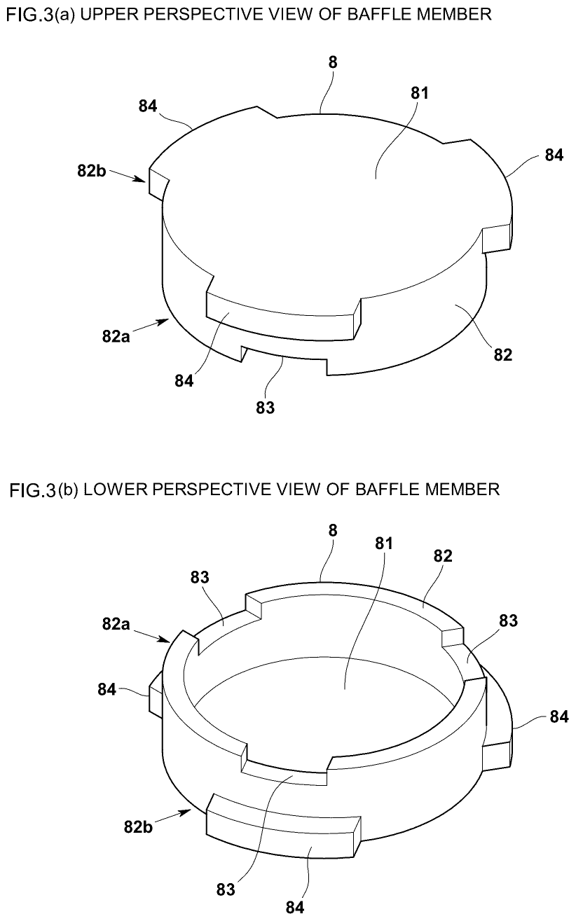

Then, the surrounding surface portion 82 has a flow passage portion 83 that allows the gas introduced from the gas introduction port 7a to flow toward the diaphragm 2 side at an end portion 82a on the gas introduction port 7a side. A plurality of the flow passage portions 83 is provided in the circumferential direction in the surrounding surface portion 82 (see FIG. 2). Specifically, the flow passage portion 83 is formed of a recessed portion which is recessed toward the diaphragm 2 at the end portion 82a of the surrounding surface portion 82 on the gas introduction port 7a side (see FIG. 3).

In addition, as illustrated in FIGS. 1 to 4, the baffle member 8 includes a plurality of joining protruding portions 84 for joining with the inner surface 7c of the housing 7. The plurality of joining protruding portions 84 is formed to protrude outward in the surrounding surface portion 82, and come into contact with the inner surface 7c of the housing 7 in a state of being accommodated in the housing 7. When the joining protruding portion 84 is joined to the inner surface 7c of the housing 7, the end portion 82a of the surrounding surface portion 82 on the gas introduction port 7a side is fixed in contact with the flat surface portion 71 of the housing 7. As a result, the gas introduced from the gas introduction port 7a flows out to the periphery of the surrounding surface portion 82 from between the recessed portion as the flow passage portion 83 and the flat surface portion 71.

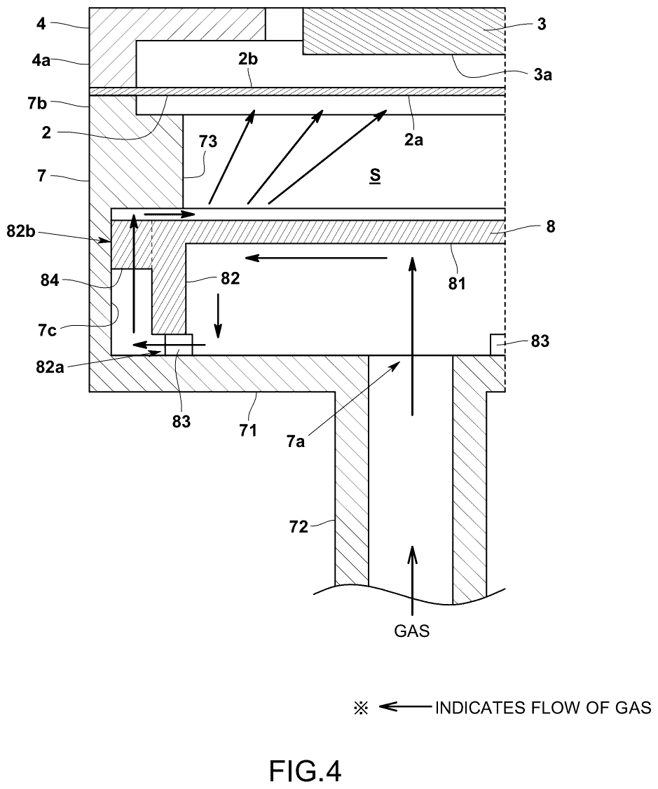

Further, as illustrated in FIGS. 1 and 4, the plurality of joining protruding portions 84 is formed on the diaphragm 2 side with respect to the flow passage portion 83 in the surrounding surface portion 82. Here, the surrounding surface portion 82 is formed at an end portion 82b opposite to the end portion 82a. Then, as illustrated in FIGS. 2 and 3, the plurality of joining protruding portions 84 is provided corresponding to the plurality of flow passage portions 83 when viewed from the gas introduction port 7a. That is, the joining protruding portion 84 and the flow passage portion 83 are provided at the same position in the circumferential direction as viewed from the gas introduction port 7a. Here, being provided at the same position in the circumferential direction means that the joining protruding portion 84 and the flow passage portion 83 are provided by being overlapped as viewed from the gas introduction port 7a. The circumferential dimension of the joining protruding portion 84 of the present embodiment is larger than the circumferential dimension of the corresponding flow passage portion 83. As a result, the gas flowing out of the flow passage portion 83 easily hits the joining protruding portion 84.

In addition, as illustrated in FIGS. 1 and 4, the housing 7 of the present embodiment has an inner protruding portion 73 that protrudes inward from the baffle member 8 on the opposite side (diaphragm 2 side) of the gas introduction port 7a with respect to the baffle member 8. The inner protruding portion 73 is provided on the entire circumference of the inner surface 7c of the housing 7 and obstructs the flow of gas flowing from the periphery of the surrounding surface portion 82 of the baffle member 8 toward the diaphragm 2.

Next, a flow of gas introduced into the measurement chamber S in the present embodiment will be described with reference to FIG. 4.

The gas introduced from the gas introduction port 7a hits the facing surface portion 81 of the baffle member 8, flows radially outward toward the surrounding surface portion 82, and flows along the surrounding surface portion 82 to the opposite side of the facing surface portion 81. That is, the traveling direction of the gas is reversed inside the baffle member 8. Then, the gas flows from the flow passage portion 83 to the outside of the surrounding surface portion 82, and flows toward the diaphragm 2 side between the surrounding surface portion 82 and the inner surface 7c of the housing 7. At this time, the gas hits the joining protruding portion 84. Thereafter, the gas hits the inner protruding portion 73 formed in the housing 7 and reaches the diaphragm 2 while flowing toward the central portion of the baffle member 8.

### Effects of Present Embodiment

As described above, according to the capacitive pressure sensor 100 of the present embodiment, the gas introduced from the gas introduction port 7a hits the facing surface portion 81 and the traveling direction is reversed, and the gas flows from the flow passage portion 83 formed at the end portion of the surrounding surface portion 82 on the gas introduction port 7a side to the diaphragm 2 side. As a result, it is possible to sufficiently secure the path of the introduced gas, mainly deposit the gas component or the gas component decomposed in the facing surface portion 81 and the surrounding surface portion 82, and reduce the deposition on the diaphragm 2. In addition, the baffle member 8 has a bottomed tubular shape including the facing surface portion 81 and the surrounding surface portion 82, the configuration of the baffle member 8 can be simplified, and the possibility of deterioration of responsiveness due to clogging of deposits or the like is extremely low. Further, since the baffle member 8 has a bottomed tubular shape, more deposits can be accumulated.

### Other Embodiments

For example, the flow passage portion 83 of the above embodiment is formed of a recessed portion formed by cutting out the end portion of the surrounding surface portion 82 in a rectangular shape, but the shape of the recessed portion such as a recessed portion cut out in a polygonal shape such as a partially circular shape or a triangular shape is not limited thereto.

In addition, the flow passage portion 83 may be formed of a through hole formed in the surrounding surface portion 82. In this case, the flow passage portion 83 formed of the through hole is provided on the gas introduction port side in the surrounding surface portion 82 in order to sufficiently secure the path of the gas.

The flow passage portion 83 of the above embodiment is formed at equal intervals in the circumferential direction, but may not be provided at equal intervals in the circumferential direction.

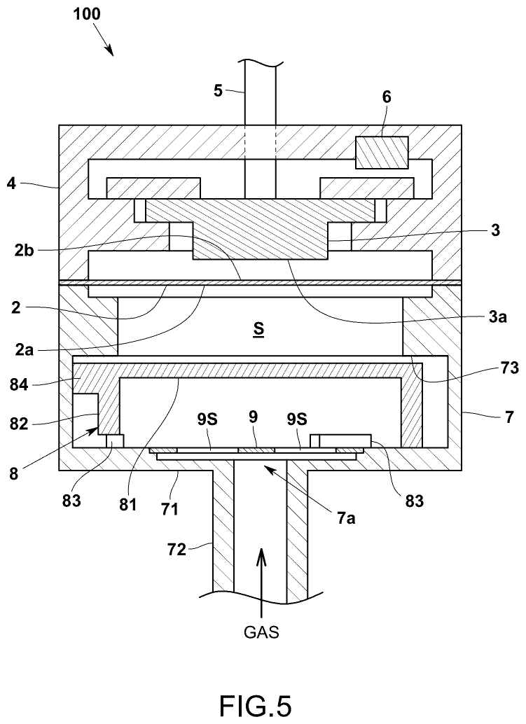

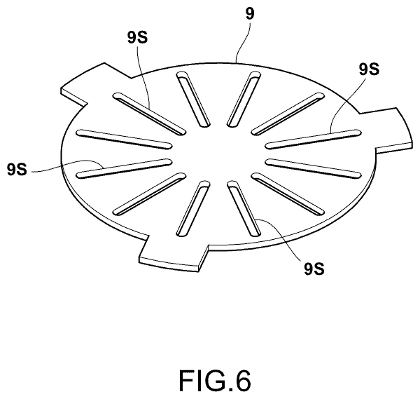

Further, as illustrated in FIGS. 5 and 6, a baffle plate 9 may be provided in addition to the baffle member 8 of the above embodiment. Specifically, the baffle plate 9 is provided separately from the baffle member 8 and is interposed between the baffle member 8 and the gas introduction port 7a. The baffle plate 9 is provided to close the gas introduction port 7a. The baffle plate 9 has, for example, a disk shape, and includes a plurality of slits 9S. Here, the plurality of slits 9S is radially formed, but the formation mode of the plurality of slits 9S is not limited thereto. With this configuration, it is possible to deposit not only the baffle member 8 described above but also a gas component and a decomposed gas component on the baffle plate 9. As a result, the deposition on the diaphragm 2 can be further reduced.

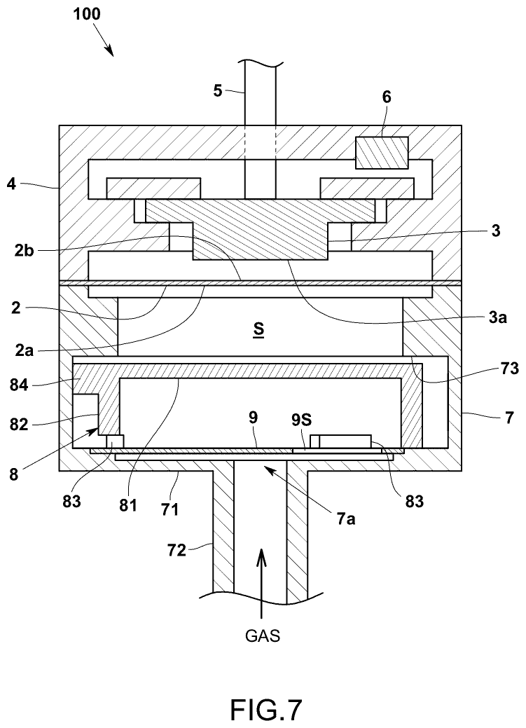

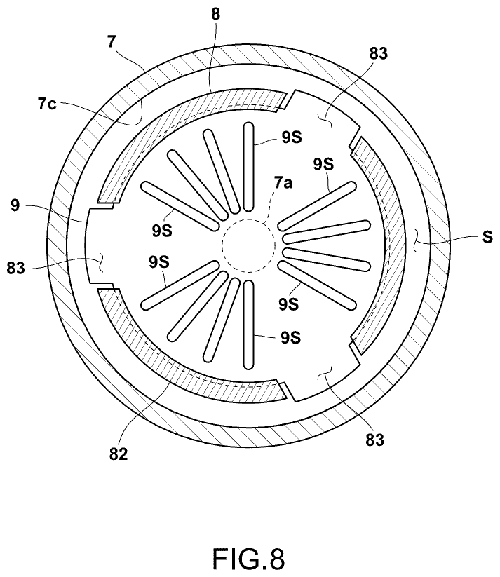

In addition, in the configuration including the baffle plate 9, as illustrated in FIGS. 7 and 8, the plurality of slits 9S is desirably formed at positions different from the flow passage portion 83 in the circumferential direction. The plurality of slits 9S is not provided at positions corresponding to the flow passage portions 83, and as illustrated in FIG. 8, the gas introduced from the gas introduction port 7a does not linearly pass through the gas introduction port 7a, the slit 9S, and the flow passage portion 83 as viewed from the introduction direction. With this configuration, the gas introduced from the gas introduction port 7a meanders also in the radial direction as viewed from the introduction direction while flowing from the slit 9S to the flow passage portion 83. As a result, the path through which the gas passing through the slit 9S of the baffle plate 9 flows can be complicated, and the deposition effect in the baffle member can be improved.

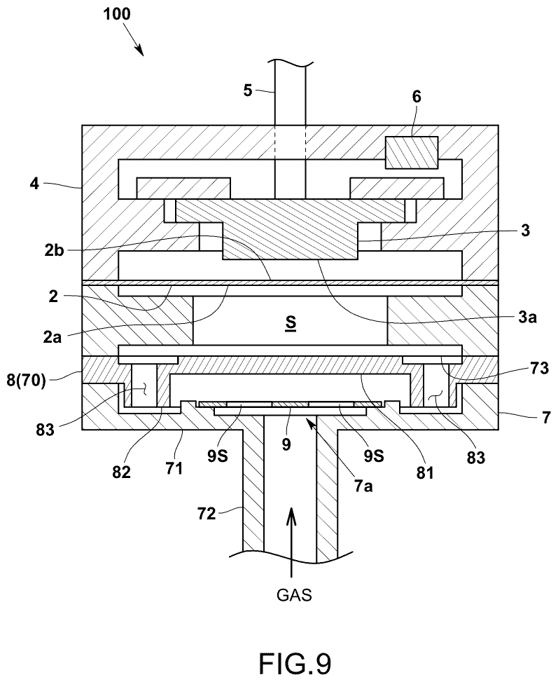

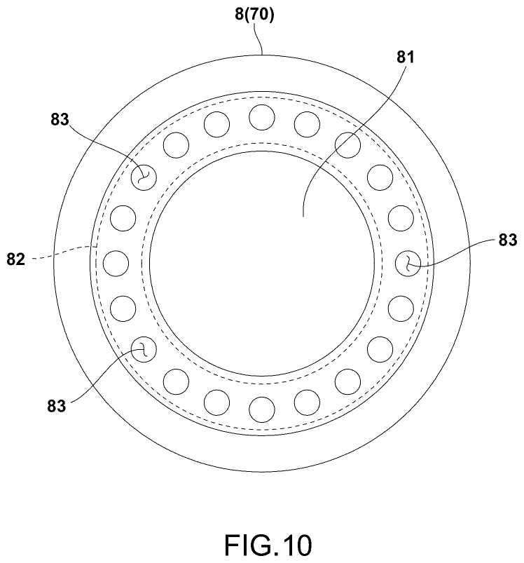

Moreover, although the baffle member 8 and the housing 7 are configured as separate members in the above embodiment, the baffle member 8 and the housing 7 may be integrally configured as illustrated in FIGS. 9 and 10. That is, the baffle member 8 and an outer wall portion 70 welded to the flat surface portion 71 of the housing 7 where the gas introduction port 7a is formed may be integrally formed. Here, the flow passage portion 83 of the baffle member 8 includes a plurality of through holes formed in the surrounding surface portion 82. Thus, when the housing 7 and the baffle member 8 are integrally formed as described above, the structure can be simplified while the flow path is complicatedly maintained.

In addition, various modifications and combinations of the embodiments may be made without departing from the gist of the present invention.
100 Capacitive pressure sensor
2 Diaphragm
2a Pressure receiving surface
3 Fixed electrode
S Measurement chamber
7 Housing
7a Gas introduction port
71 Flat surface portion
73 Inner protruding portion
8 Baffle member
81 Facing surface portion
82 Surrounding surface portion
83 Flow passage portion
84 Joining protruding portion
9 Baffle plate
9S Slit

What is claimed is:

1. A capacitive pressure sensor that measures pressure by detecting a change in capacitance between a diaphragm and a fixed electrode displaced by pressure, the capacitive pressure sensor comprising:
a housing surrounding a pressure receiving surface of the diaphragm to form a measurement chamber, the housing having a gas introduction port for introducing a gas into the measurement chamber; and
a baffle member provided in the measurement chamber, wherein
the baffle member includes:
a facing surface portion facing the gas introduction port; and
an surrounding surface portion provided closer to a side of the gas introduction port than the facing surface portion and surrounding a periphery of the gas introduction port, and
the surrounding surface portion includes a flow passage portion that allows a gas introduced from the gas introduction port to flow from an end portion on the side of the gas introduction port side toward a side of the diaphragm.

2. The capacitive pressure sensor according to claim 1, wherein a plurality of the flow passage portions is provided in a circumferential direction in the surrounding surface portion.

3. The capacitive pressure sensor according to claim 1, wherein
the baffle member includes a joining protruding portion for joining with an inner surface of the housing, and
the joining protruding portion is provided corresponding to the flow passage portion as viewed from the gas introduction port.

4. The capacitive pressure sensor according to claim 1, wherein
the housing has a flat surface portion in which the gas introduction port is formed, and
an end portion of the surrounding surface portion on the side of the gas introduction port is provided in contact with the flat surface portion.

5. The capacitive pressure sensor according to claim 1, wherein the housing includes an inner protruding portion protruding inward from the baffle member on a side opposite to the gas introduction port with respect to the baffle member.

6. The capacitive pressure sensor according to claim 1, further comprising a baffle plate provided separately from the baffle member and interposed between the baffle member and the gas introduction port.

7. The capacitive pressure sensor according to claim 6, wherein a plurality of slits is formed in the baffle plate.

8. The capacitive pressure sensor according to claim 7, wherein the plurality of slits is formed at positions different from the flow passage portion in the circumferential direction.
